(19) United States
(12) Patent Application Publication
(10) Pub. No.: US 2014/0310183 A1
(43) Pub. Date: Oct. 16, 2014

(54) EMBEDDED ACCEPTANCE SYSTEM

(71) Applicant: LANCE WEBER, LONGMONT, CO (US)

(72) Inventor: LANCE WEBER, LONGMONT, CO (US)

(21) Appl. No.: 14/253,188

(22) Filed: Apr. 15, 2014

Related U.S. Application Data
(60) Provisional application No. 61/812,168, filed on Apr. 15, 2013.

(51) Int. Cl. G06Q 20/38

(52) U.S. Cl. CPC G06Q 20/3829
USPC 705/71; 705/39

(57) ABSTRACT

Methods and systems can provide for unified processing of merchant transactions over various payment channels over which the transactions originate, such as in-person retail transactions and e-commerce transactions. For example, transactions can be received from payment channels through different payment channel-specific interfaces. The transactions from the various payment channels can then be sent to an entry point module that centrally manages the transactions. An orchestrator can then identify payment channel-agnostic transaction services to be applied to the transactions. This can allow for a unified end-to-end encryption implementation across a merchant's enterprise, reducing management costs and improving overall security. Similarly, universal tokenization services, payment and fraud management can be provided across a merchant's entire enterprise.

### CROSS-REFERENCES TO RELATED APPLICATIONS

This application is a non-provisional application of and claims priority to U.S. Provisional Application No. 61/812,168 titled “EMBEDDED ACCEPTANCE SYSTEM”, filed Apr. 15, 2013, which is herein incorporated by reference in its entirety for all purposes.

### BACKGROUND

Today consumers have many different ways to purchase goods or services from a particular merchant. For example, goods and services may be purchased from the merchant remotely over the Internet or may be purchased in person at a store operated by the merchant. Purchases made over the internet may be made at the merchant's e-commerce website, through a mobile app, or through other purchasing channels; similarly, in person purchases may be made using a payment card or a mobile device and mobile wallet. Additionally, the transaction data received through these different payment processes can be different. For example, the merchant may receive tokenized transaction data in an Internet transaction while the same merchant may receive non-tokenized transaction data when a transaction is conducted at the merchant's store.

Traditionally, transactions conducted over different payment processes are processed by different systems, adapted to the different transaction data provided over those payment processes, and providing different services to those transactions. This results in a fragmented view of a merchant's transactions, with different transactions receiving different services and limiting the ability to analyze all of a merchant's transactions. In some cases, such an incomplete view can result in increased risk of fraud or other malicious behavior that takes advantage of these limitations.

Additionally, to ensure secure transactions, merchants typically have to manage different encryption mechanisms for each of the different systems they use to process their transactions. This adds additional management costs and may increase the risk that the merchant's systems become out of date and less secure.

Embodiments of the invention address these and other problems.

### BRIEF SUMMARY

Consumers can buy goods and services from a merchant over many different payment channels, such as in-person at a retail store or online. Transactions conducted over different payment channels may include different transaction data and may be processed by different systems that are configured for particular types of transaction data. The different systems, in turn, may be configured to provide different types of services at different stages during transaction processing. Embodiments of the present invention are directed to methods and systems for unified processing of merchant transactions, regardless of the payment channel over which the transactions originate. The same payment channel-agnostic transaction services can be applied to any or all transactions processed by a merchant. This can allow for a unified end-to-end encryption implementation across a merchant's enterprise, reducing management costs and improving overall security. Similarly, universal tokenization services, payment and fraud management can be provided across a merchant's entire enterprise.

One embodiment of the invention is directed to a method of processing transactions received over a plurality of different payment channels. A server computer receives first transaction data for a first transaction initiated at a merchant access device through a first channel interface of the server computer. The server computer also receives second transaction data for a second transaction initiated at a user computer through a second channel interface of the server computer. The first transaction data is sent, via the first channel interface, to an entry point module of the server computer. The second transaction data is sent, via the second channel interface, to the entry point module of the server computer. The entry point module adds the first transaction data and the second transaction data to a queue. An orchestrator processes the first transaction data and the second transaction data from the queue, the orchestrator configured to perform a plurality of service functions for a transaction using corresponding transaction data. The orchestrator also generates a first response message corresponding to the first transaction data and a second response message corresponding to the second transaction data. The first response message is returned through the first channel interface to the merchant access device and the second response message is returned through the second channel interface to the user computer.

Another embodiment of the invention is directed to a method for managing encryption of transactions. A server computer sends one or more first encryption keys to a first merchant computer. The first merchant computer injects the one or more encryption keys into a plurality of first terminals. The server computer also sends one or more second encryption keys to a second merchant computer. The second merchant computer injects the one or more encryption keys into a plurality of second terminals. The server computer receives encrypted first transaction data for a first transaction initiated at one of the plurality of first terminals through a first channel interface of the server computer. The server computer also receives encrypted second transaction data for a second transaction initiated at one of the plurality of second terminals through a second channel interface of the server computer. A decryption module at the server computer decrypts the encrypted first transaction data using at least one of the first encryption keys. The decryption module at the server computer also decrypts the encrypted second transaction data using at least one of the second encryption keys. The server computer processes the first transaction data and second transaction data using a plurality of service modules.

Other embodiments are directed to systems and computer readable media associated with methods described herein.

Further details regarding embodiments of the invention can be found in the Detailed Description and the Figures.

### BRIEF DESCRIPTION OF THE DRAWINGS

FIG. 1 illustrates an example block diagram of an example payment transaction system with separate payment channels.

FIG. 2 illustrates an example block diagram of an example payment transaction system within a merchant processor computer that supports multiple payment channels, according to embodiments of the present invention.

FIG. 3 illustrates an example block diagram of an example payment transaction system with multiple payment channels including retail (i.e., brick and mortar) as well as online (i.e., e-commerce) transaction processing systems, according to embodiments of the present invention.

FIG. 4 illustrates an example block diagram of a channel interface according to embodiments of the invention.

FIG. 5 illustrates an example merchant processor computer according to embodiments of the invention.

FIG. 6 illustrates an example payment processing network according to embodiments of the invention.

FIG. 7. is a flowchart of a method for processing payment transactions according to embodiments of the present invention.

FIG. 8 illustrates an example block diagram of an encryption management system of a payment transaction system with separate payment channels, according to embodiments of the present invention.

FIG. 9 shows a system and a corresponding workflow for configuring switches in multiple payment channels according to embodiments of the present invention.

FIG. 10 is a flowchart of a method for managing encryption in a payment processing system according to embodiments of the present invention.

FIG. 11 shows a block diagram of a computer apparatus.

### DEFINITIONS

Prior to discussing embodiments of the invention, some descriptions of some terms may be helpful in understanding embodiments of the invention.

The term “server computer” may include a computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

The term “client computer” may include any suitable computational apparatus. The client computer may be operated by a consumer, a user associated with a merchant, or any other individual. The client computer may use any suitable wired or wireless network, including the Internet, in order to communicate with other systems. For example, a consumer client computer may be used by a consumer to interact with a merchant Internet storefront in order to conduct a transaction. A merchant client computer may be used by a user associated with a merchant to interact with other merchant computer systems and a fraud detection system. Examples of computers and consumer mobile devices include any device capable of accessing the Internet, such as a personal computer, cellular or wireless phones, personal digital assistants (PDAs), tablet PCs, and handheld specialized readers.

The term “database” may include any hardware, software, firmware, or combination of the preceding for storing and facilitating retrieval of information. Also, the database may use any of a variety of data structures, arrangements, and compilations to store and facilitate retrieval of information.

The term “transaction data” may include any data associated with one or more transactions. In some embodiments, the transaction data may merely include an account identifier or payment token. Alternatively, in other embodiments, the transaction data may include any information generated, stored, or associated with a merchant, consumer, account, or any other related information to a transaction. For example, transaction data may include data in an authorization request message that is generated in response to a payment transaction being initiated by a consumer with a merchant. Alternatively, transaction data may include information associated with one or more transactions that have been previously processed and the transaction information has been stored on a merchant database or other merchant computer. The transaction data may include an account identifier associated with the payment instrument used to initiate the transaction, consumer personal information, products or services purchased, or any other information that may be relevant or suitable for transaction processing. Additionally, the transaction information may include a payment token or other tokenized or masked account identifier substitute that may be used to complete a transaction and protect the underlying account information of the consumer.

Additionally, in some embodiments, there may be different types of transaction data including e-commerce transaction data, retail transaction data, mobile transaction data, etc. For example, each type of transaction data may be dependent on the type of transaction or the channel in which the transaction is initiated (e.g., an e-commerce transaction initiated over the internet may generate e-commerce transaction data). Each type of transaction data may comprise different types of data or may comprise the same type of data. For example, a retail transaction may generate retail transaction data when a consumer swipes a credit card at a point-of-sale terminal of a merchant. The retail transaction data may comprise Track 1 and/or Track 2 payment data included on the magnetic stripe or chip of the consumer's credit card (or other payment device). Accordingly, the retail transaction data may comprise the Track 1 and/or Track 2 data as well as additional data associated with the consumer, merchant, account associated with the payment device, or any other information.

Furthermore, in some embodiments, multiple types and instances of transaction data may be received and processed. For example, “first transaction data” and “second transaction data” may include separate transaction data that is generated by transactions that are separated by time, merchant, merchant location, consumer location, transaction type, or any other variable that would cause transaction data associated with a single consumer account to be separated into two different messages or pieces of data. For example, first transaction data may be related to a first transaction originated at a first time and second transaction data may relate to a second transaction initiated at a second time. In some embodiments, the first transaction data and the second transaction data may be received by components within the transaction system at the same time (e.g., in a single communication message) or may be received at two different times (e.g., in separate messages). Accordingly, transaction data may comprise any number of transaction data (e.g., first transaction data, second transaction data, third transaction data, etc.) associated with any number of transactions. First transaction data and second transaction data may be related to transactions that are completed by the same consumer or another person using the consumer's same underlying primary account identifier. For example, a consumer may initiate a first transaction that generates first transaction data and then a friend or agent of the consumer may initiate a second transaction on behalf of the consumer using their credit card or other payment device that generates second transaction data.

### DETAILED DESCRIPTION

Consumers can buy goods and services from a merchant over many different payment channels, such as in-person at a retail store and online through an e-commerce website. Transactions conducted over different payment channels may include different transaction data and may be processed by different systems that are configured for particular types of transaction data. The different systems, in turn, may be configured to provide different types of services at different stages during transaction processing. For example, one system may be configured to only analyze transaction data after authorization has occurred, whereas another system may be configured to perform customer recognition, tokenization, and other value-added services prior to or concurrent with authorization. This means that some portions of a merchant's transactions will receive less sophisticated processing due to the payment channel, even transactions for the same goods made by the same consumers.

Additionally, because separate transaction processing systems are used to process transactions over different payment channels, analysis of all transactions associated with a given merchant can be difficult. For example, transactions made by the same user with the same merchant over different payment channels may result in very different transaction data that cannot readily be correlated. This results in piecemeal analysis of a merchant's transactions, leaving the merchant with a greater risk for fraud, and generally providing the merchant with a lower level of service.

Example embodiments are typically implemented in the context of a financial transaction. Therefore, prior to further discussing an account detection capability within fraud detection, a brief description of transaction processing will be presented.

### I. SYSTEM OVERVIEW

### A. Example Architecture

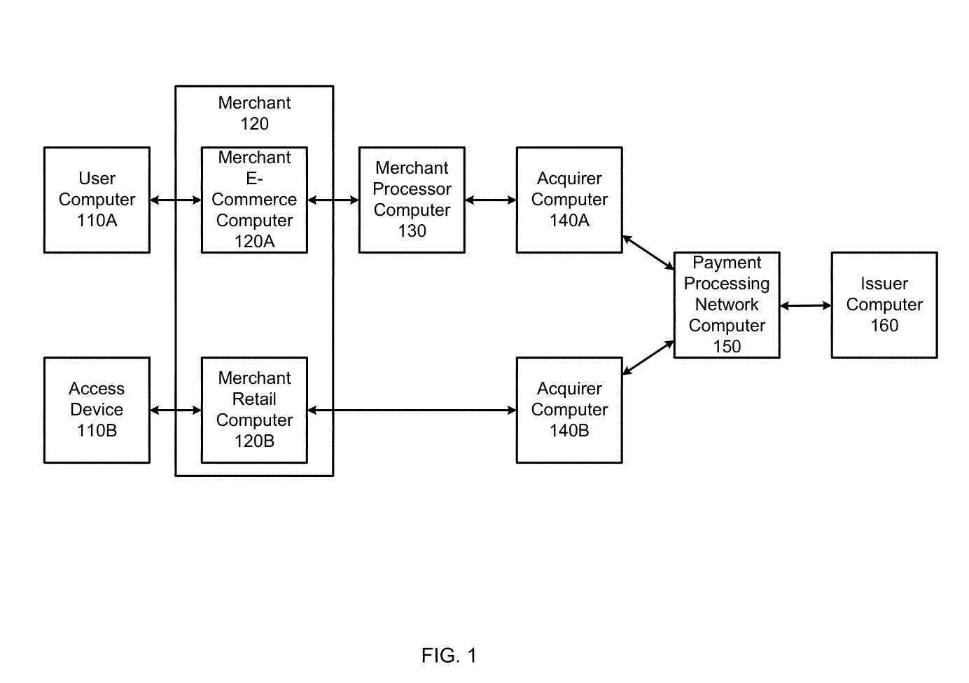

FIG. 1 illustrates an example block diagram of an example payment transaction system with two separate payment channels including retail (i.e., brick and mortar) as well as online (i.e., e-commerce) transaction processing systems. According to embodiments of the present invention, a transaction processing system may include multiple payment channels, each with a unique transaction flow. For example, the transaction processing system of FIG. 1 shows a transaction processing system capable of processing both retail and e-commerce payment transactions.

The retail transaction processing channel may comprise a typical transaction system including an access device 110B, a merchant 120 including a merchant retail computer 120B, an acquirer computer 140B, a payment processing network computer 150, and an issuer computer 160.

As used herein, an “issuer” may typically refer to a business entity (e.g., a bank or other financial institution) that maintains financial accounts for the user and often issues a payment device such as a credit or debit card to the user. As used herein, a “merchant” may typically refer to an entity that engages in transactions and can sell goods or services to the user or consumer. As used herein, an “acquirer” may typically refer to a business entity (e.g., a commercial bank or financial institution) that has a business relationship with a particular merchant 120 or similar entity. Some entities can perform both issuer and acquirer functions.

An access device 110B may include a merchant point-of-sale (POS) device, a consumer's mobile communication device, or any other device that is capable of communicating payment information to a merchant retail computer 120B.

A merchant retail computer 120B may be in electrical communication with the access device 110B and may include any server computer programmed to process and manage retail transactions for a merchant 120. As used herein, a “server computer” is typically a powerful computer or cluster of computers. For example, the server computer can be a large mainframe, a minicomputer cluster, or a group of servers functioning as a unit. In one example, the server computer may be a database server coupled to a Web server.

An acquirer computer 140B may be configured to electrically communicate with the merchant retail computer 120B and a payment processing network computer 150.

A payment processing network may be disposed between the acquirer computer 140B and the issuer computer 160 in the system. Furthermore, the merchant retail computer 120B, the acquirer computer 140B, the payment processing network, and the issuer computer 160 may all be in operative communication with each other (i.e. although not shown in FIG. 1, one or more communication channels may exist between each of the entities, whether or not these channels are used in conducting a financial transaction).

The payment processing network may include data processing subsystems, networks, and operations used to support and deliver authorization services, exception file services, and clearing and settlement services. For example, the payment processing network may comprise a server computer and databases of information. An example payment processing network may include, for example, VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network may use any suitable wired or wireless network, including the Internet.

A typical credit card transaction flow using a payment device at an access device 110B (e.g., POS location) can be described as follows. (Note that embodiments of the invention are not limited to credit card transactions, but may also include other types of payment transactions including prepaid and debit transactions). A user presents his or her payment device to an access device 110B to pay for an item or service. The payment device and the access device 110B interact such that information from the payment device (e.g., PAN, verification value(s), expiration date, etc.) is received by the access device 110B (e.g., via contact or contactless interface). The merchant retail computer 120B may then receive this information from the access device 110B via the external communication interface. The merchant retail computer 120B may then generate an authorization request message that includes the information received from the access device 110B (i.e., information corresponding to the payment device) along with additional transaction information (e.g., a transaction amount, merchant specific information, etc.) and electronically transmit this information to an acquirer computer 140B. The acquirer typically represents, and vouches for, the merchant in financial transactions (e.g., credit card transactions). The acquirer computer 140B may then receive, process, and forward the authorization request message to a payment processing network for authorization.

In general, prior to the occurrence of a credit-card transaction, the payment processing network 150 has an established protocol with each issuer on how the issuer's transactions are to be authorized. In some cases, such as when the transaction amount is below a threshold value, the payment processing network may be configured to authorize the transaction based on information that it has about the user's account without generating and transmitting an authorization request message to the issuer computer 160. In other cases, such as when the transaction amount is above a threshold value, the payment processing network may receive the authorization request message via its external communication interface, determine the issuer associated with the payment device, and forward the authorization request message for the transaction to the issuer computer 160 for verification and authorization. As part of the authorization process, the payment processing network or the issuer computer 160 may analyze a verification value or other datum provided by the payment device. The verification value may be stored at the issuer or the payment processing network (e.g., in one or more of databases). Once the transaction is authorized, the issuer computer 160 may generate an authorization response message (that may include an authorization code indicating the transaction is approved or declined) and transmit this electronic message via its external communication interface to payment processing network. The payment processing network may then forward the authorization response message via a communication channel to the acquirer computer 140B, which in turn may then transmit the electronic message to comprising the authorization indication to the merchant retail computer 120B.

In the credit card industry, for example, the authorization indication typically takes the form of an authorization code, which is five or six alphanumeric characters, by convention. It serves as proof to the merchant 120 and the consumer that the issuing bank or payment processing network has authorized the transaction, and may be used by the merchant 120 or the consumer as proof of authorization if the issuing bank later disputes the transaction, such as during settlement.

When a user wishes to make an online purchase with a merchant 120 over the Internet (i.e. e-commerce), a similar method as described above may be performed except that the user may use his computer apparatus or mobile device to provide information associated with a payment device (e.g., account number, user's name, expiration date, verification value, etc.) into respective fields on the merchant's checkout page (e.g., functioning as user computer 110A). The user computer 110A may then provide this information to the merchant e-commerce computer 120A for processing.

The transaction processing system of FIG. 1 also includes an e-commerce transaction processing channel. The e-commerce transaction processing system (i.e., e-commerce transaction channel) may include a user computer 110A, a merchant 120 including a merchant e-commerce computer 120A, a merchant processor computer 130, an acquirer computer 140A, a payment processing network computer 150, and an issuer. Although merchant processor computer 130 is shown as communicating with payment processing network computer 150 via acquirer computer 140A, in some embodiments, merchant processor computer 130 may communicate directly with payment processing computer 150. In such embodiments, merchant processor computer may communicate with acquirer computer 140A periodically (e.g., at the end of each day), to perform settlement. As is shown in FIG. 1, many of the entities may be the same for both e-commerce and retail transaction channels. For example, the payment processing network, issuer, and in some embodiments, the acquirer computer may be the same for both transaction channels.

A user computer 110A may include any device operated by a consumer that may communicate with a merchant e-commerce computer 120A. For example, a user computer 110A may include a user's smartphone, tablet, laptop, kiosk operated by a consumer, or any other electronic device capable of communicating with a merchant e-commerce computer 120A.

A merchant e-commerce computer 120A may comprise one or more server computers that are configured to communicate with a user computer 110A and/or a merchant processor computer 130. The merchant e-commerce computer 120A may be coupled to an e-commerce merchant database that may comprise merchant goods and services that may be listed for sale by the merchant 120 and may be purchased by a consumer over the internet. Accordingly, the merchant e-commerce computer 120A may be capable of delivering web content to a user computer 110A, receiving information, commands, and/or requests from the consumer, and may process a transaction or collaborate with a merchant processor computer 130 to process a transaction requested by a consumer.

A merchant processor computer 130 may include any server computer that is configured to communicate with a merchant e-commerce computer 120A and an acquirer computer 140A. A merchant processor computer 130 may receive e-commerce transaction data from the merchant e-commerce computer 120A. The e-commerce transaction data may comprise transaction data including transaction details (e.g., transaction amount, time, date, merchant identifier, etc.) as well as a payment token associated with a consumer's primary account identifier. The consumer may enter or provide their primary account identifier during a checkout or other payment initialization phase with the merchant's website.

For example, in some embodiments, the consumer may provide their primary account identifier through a hosted order page (HOP) or stop order page (SOP) that may be delivered by the merchant processor computer 130 to the user computer 110A as part of the transaction initiation process. Accordingly, the merchant e-commerce computer 120A may be configured such that the merchant 120 does not have to store or even have access to a consumer's payment information during a transaction. Instead, the merchant e-commerce computer 120A may incorporate the merchant processor computer 130 to process the online payment transaction. The merchant processor computer 130 may deliver a HOP or SOP as part of a transaction payment initialization or payment checkout of a merchant's e-commerce website. The HOP/SOP may allow a consumer to enter their payment details or otherwise sign into their pre-configured account. The information may be passed to the merchant processor computer 130, which may comprise a database of consumer information.

The database of consumer information may store a consumer's primary account identifier during a registration step for the service or at checkout of the merchant's website. In some embodiments, after registration, the HOP/SOP may not pass a primary account identifier over the internet or other communication network used to complete the transaction. Instead, the HOP/SOP may generate a payment token during transaction initialization or submission at checkout. The payment token may be derived from the primary account identifier that a consumer may enter into the checkout page. The payment token may be considered a tokenized account identifier. The tokenization may be accomplished by applying any suitable tokenization algorithm, scheme, or process, as one of ordinary skill would recognize. Additional information regarding the HOP/SOP pages, the payment token, and the interaction between the merchant e-commerce computer 120A and the merchant processor computer 130 may be found in U.S. patent application Ser. No. 13/559,250, filed Jul. 26, 2012, by McCullagh et al., the disclosure of which is hereby incorporated by reference in its entirety for all purposes.

The merchant processor computer 130 may receive the payment token and may determine a primary account identifier associated with the payment token. The merchant processor computer 130 may then process the transaction by forwarding the primary account identifier associated with the payment token to an appropriate payment processor network computer 150 or acquirer computer 140A.

Once at the acquirer computer 140A, the transaction processing may continue as a typical payment transaction may be processed, as described above in reference to the retail payment transaction processing. In payment token processing, a request for an authorization of a payment transaction is being generated, processed through the request being sent to an acquirer computer 140A, payment processing network computer 150, and an issuer computer 160, and an authorization response message including whether the transaction is authorized is returned to the merchant 120 and consumer. Thus, although the payment token processing is not a typical ISO message, as described above in reference to the retail payment transaction, the e-commerce payment transaction request may also be referred to as an authorization request message. . Accordingly, both e-commerce and retail payment transactions may include authorization request message and authorization response message processing.

However, the authorization response message may have the primary account identifier substituted with the payment token when returned to the merchant processor computer 130 so that the merchant e-commerce computer 120A does not gain access to the primary account identifier and the system's security is maintained. Accordingly, the merchant 120 may only receive a payment token and may not receive the primary account identifier during an e-commerce transaction with a consumer. However, such a payment token is not generated during the retail transaction processing. Accordingly, transactions completed using the same consumer's primary account identifier may result in two different values at a merchant 120. Because the retail transactions bypass the merchant processor computer 130, the merchant processor computer cannot provide the same services to the retail transactions and the e-commerce transactions. This may make it difficult to correlate different transactions from the same user, limiting the effectiveness of fraud and risk analyses performed on the merchant's transactions.

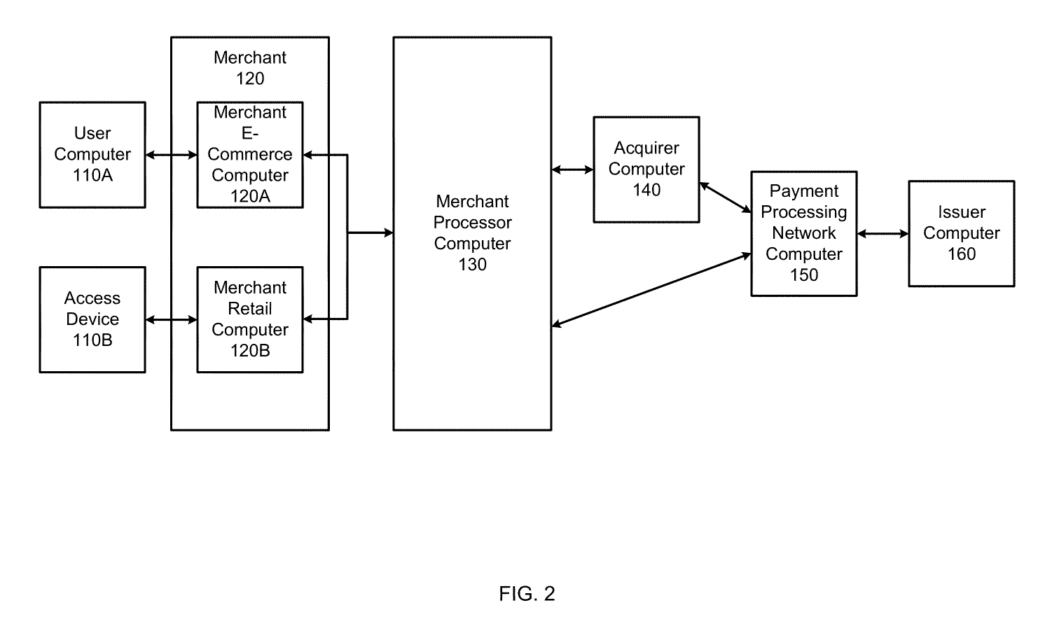

FIG. 2 illustrates an example block diagram of an example payment transaction system within a merchant processor computer that supports multiple payment channels, according to embodiments of the present invention. As shown in FIG. 2, in some embodiments merchant processor computer 130 may be configured to communicate with a merchant 120 through a plurality of different payment channels, such as an e-commerce channel with merchant e-commerce computer 120A and a retail channel with merchant retail computer 120B. This allows merchant processor computer 130 to process any or all transactions from a merchant regardless of the payment channel over which those transaction originate. Although the two payment channels shown in FIG. 2 include retail transactions which are initiated through an access device 110B and e-commerce transactions initiated through a user computer 110A, various payment channels originating with various merchant computers or devices may also be supported.

Retail transactions can broadly include a retail point of sale (POS) channel (e.g., corresponding to checkout lanes at a retail store), a mobile point of sale channel (e.g., corresponding to mobile POS terminals, such as tablet computers that have been configured to serve as access devices, that allow merchants to checkout consumers anywhere in the store), and a stand-alone kiosk channel (e.g., self-service fuel stations, bill pay kiosks, or other self-service terminals). Each of these retail channels may include different access devices that are configured to communicate over different communication systems, however each retail channel receives track data, including track 1 and track 2 data, as described above, from the consumer's payment device.

Similarly to FIG. 1, merchant processor computer may communicate with payment processing network computer through acquirer computer 140. In some embodiments, merchant processor computer 130 may communicate directly with payment processing network computer 150, and periodically communicate with acquirer computer 140 to perform settlement or other functions. Unlike the embodiment shown in FIG. 1, in the embodiment shown in FIG. 2, the merchant 120 and the merchant processor computer 130 have each been reconfigured such that transactions that originate over the merchant's retail channels and e-commerce channels are all directed to the merchant processor computer 130. This allows greater uniformity in which services provided by the merchant processor computer 130 can be applied across the merchant's transactions. This generally improves the value of these services to the merchant and can provide improved security, fraud detection, risk analysis, and other transaction services to the merchant, at lower cost to the merchant.

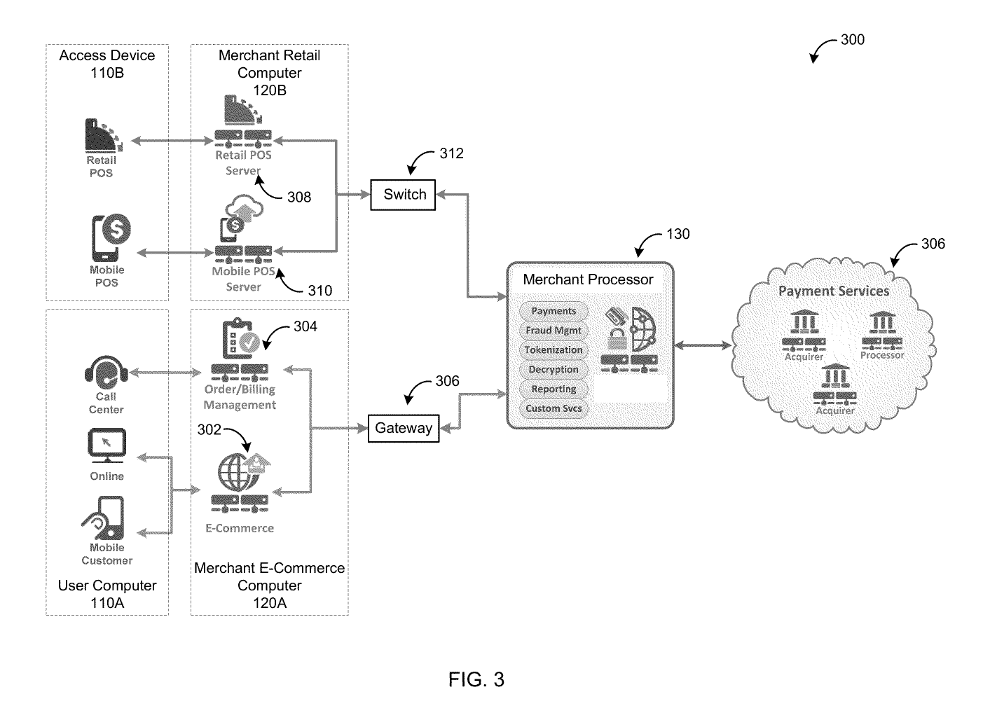

Additional details of the system shown in FIG. 2 and the services provided are provided below with respect to FIGS. 3-10.

B. Payment Channels

FIG. 3 illustrates an example block diagram of an example payment transaction system 300 with multiple payment channels including retail (i.e., brick and mortar) as well as online (i.e., e-commerce) transaction processing systems, according to embodiments of the present invention. As shown in FIG. 3, a consumer can conduct an e-commerce transaction with a merchant using a user computer 110A. A user computer can include any Internet-enabled or telecommunications device. For example, a consumer may access a merchant's e-commerce website 302 using a mobile device (such as a smartphone, tablet computer, laptop computer, or other mobile device), a desktop computer, or any other Internet-enabled device. Similarly, a consumer may place an order using a telecommunications device, such as a telephone, by placing a voice call or sending a SMS message, instant message, fax or other telecommunications message to a call center.

An operator in the call center may then place the consumer's order through an order/billing management system 304. Each e-commerce transaction may result in e-commerce transaction data including, a payment identifier (such as a PAN, tokenized PAN, or other identifier), billing address, shipping address, user profile information, transaction history, and other consumer data. The e-commerce transactions may be sent from the merchant e-commerce computer 120A to an e-commerce gateway 306 which can then route the transactions to merchant processor 130.

In some embodiments, e-commerce gateway 306 may be integrated with a merchant's e-commerce enterprise system. In other embodiments, e-commerce gateway 306 may be hosted on one or more server computers operated by merchant processor 130. In some embodiments, each merchant e-commerce computer may be configured to send transactions directly to merchant processor computer 130, without an intervening e-commerce gateway. E-commerce gateway 306 may be a server computer operated by the merchant or a third party service provider that provides message routing services to between one or more merchant e-commerce computers and merchant processor 130. In some embodiments, each e-commerce gateway may be configured to push software updates to merchant e-commerce computers, including security updates and transaction workflow updates.

As shown in FIG. 3, a merchant can also offer various payment channels for a consumer to use at the merchant's retail location. For example, access device 1108 can include retail point of sale (POS) terminals, such as those used at retail checkout aisles, and mobile POS terminals, such as a tablet computer configured to receive payment data from a consumer's payment device and operate as a POS. Self-service kiosks and other access devices may also be provided by a merchant to reduce wait times and improve the consumer's experience. Each access device 110B provided by the merchant may offer different services, generate different transaction data, and require separate configuration. This can present a device management problem for merchants.

A retail switch 312 can be used for device management. Retail switches can be configured to be interoperable with many different access device types from different access device manufacturers. The retail switch 312 allows the merchant to perform configuration once and have that configuration pushed to all access devices in communication with the retail switch 312. The retail switch can configure each terminal to follow a specified transaction workflow and to use appropriate encryption keys and security procedures. The transaction workflow may include a series of steps that prompts the consumer to provide information to complete the transaction. For example, a transaction workflow may begin by prompting the user to provide a loyalty account number, coupon identifiers, or provide any other incentive information. The transaction workflow may then prompt the consumer to select a payment method, such as credit or debit, and provide payment data (e.g., by swiping or tapping a payment device).

Based on the user's selection, the transaction workflow may prompt the user for additional information (e.g., to enter a PIN or to provide a signature). The transaction workflow can encrypt the data provided by the user and generate an authorization request message using the encrypted data to be sent to an acquirer computer or merchant processor via the retail switch. The retail switch may receive all transaction requests from the merchant's access devices. Or, in the case of large merchants, a cascade of switches may be implemented such that each merchant location has a dedicated retail switch that forwards messages to a regional switch, which then routes messages to acquirer computers and/or merchant processor computers. Responses from the merchant processor to the merchant computer can then be sent over a similar message path that traverses the merchant's enterprise through the plurality of switches.

In some embodiments, each retail switch 312, can route messages to a plurality of different locations. Typically, a retail switch may route all credit card transactions to a credit card endpoint located at a credit card acquirer computer, all debit card transactions to a debit card endpoint at a debit card acquirer, all gift card transactions to a gift card endpoint at a gift card acquirer, etc. In accordance with an embodiment, retail switch 312 can be configured to direct transactions to a plurality of transaction-type specific channel interfaces at merchant processor 130 rather than directly to one or more acquirer computers. This allows for the built in functionality of each switch (e.g., encryption management and transaction workflow management) to be utilized while also providing the same level of transaction services to both retail and e-commerce transactions.

In some embodiments, the switch can be configured to identify the payment channel over which a transaction is sent. For example, the switch may identify transactions received from a mobile POS, from a kiosk, from a retail POS, and any other retail payment channel. Based on the payment channel, the switch can determine an address, such as an IP address, for a corresponding channel interface at merchant processor 130. In some embodiments, the switch may be configured to generate a standards-based message, such as an ISO 8583, to be sent to the corresponding channel interface. In some embodiments, the switch may be configured to transform the standards-based message according to an API published by merchant processor 130.

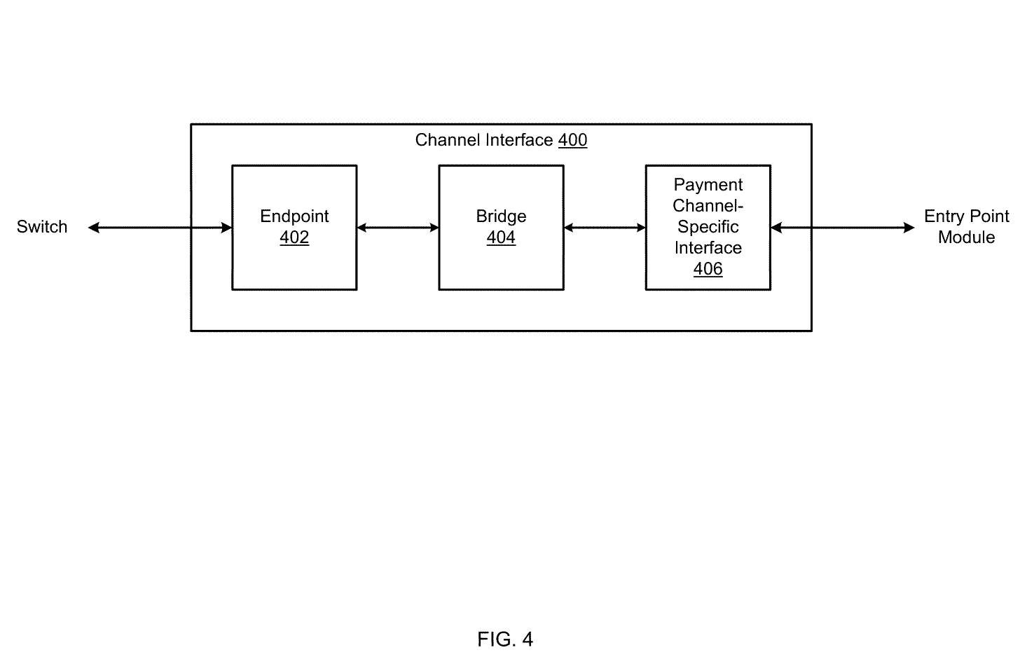

As discussed further below with respect to FIG. 4, once transactions are received by the merchant processor from switch 312 and gateway 306, the transactions may be placed in a queue and processed in sequence or in parallel using a plurality of transaction services, such as payment services, fraud management services, tokenization services, decryption services, reporting services, and other services, regardless of the payment channel over which the transaction was sent. This enables transaction services to be applied to both e-commerce and retail transactions associated with a merchant, improving the quality of the analysis and value of the services to the merchant.

### C. Merchant Processor

FIG. 4 illustrates an example block diagram of a channel interface according to embodiments of the invention. As described above, switch 312 can be configured to send transactions to a plurality of channel interfaces at merchant processor 130, based on the payment channel over which the transaction originated. As shown in FIG. 4, a channel interface 400 can include an endpoint 402, a bridge 404 and a payment channel-specific interface 406. Each address to which switch 312 is configured to send messages corresponds to a different endpoint 402. In the example shown in FIG. 4, endpoint 402 is the network connection that receives messages from switch 312 that originate over the corresponding payment channel. Each endpoint may be configured to receive messages from switch 312 in a particular protocol (e.g., TCP). In some embodiments, each endpoint represents a single logical location to which all requests originating on the corresponding payment channel can be sent. In some embodiments, requests that are received at that logical location may be load balanced and forwarded to one of a plurality of physical nodes within the merchant processor's infrastructure.

As described above, switches are typically configured to send standards-based messages, such as ISO 8583 messages, to acquirer computers. However, because these messages have traditionally bypassed merchant processor computers, merchant processors are not configured to recognize or operate on these standards-based messages. Bridge 404 can listen for these messages from the switch 312, and transform the contents of the messages into a merchant processor format such that they can be processed by merchant processor 130. In some embodiments, bridge 404 can be a software module that is configured to monitor endpoint 402 for connections over a particular protocol. For example, bridge 404 may be configured to listen for any TCP connections and capture any data received over the TCP connections. Bridge 404 can include one or more adapters corresponding to each type of standards-based message that it is listening for. The bridge can analyze messages, extract data from the messages according to the format of the received message using a corresponding adapter, and insert the extracted data into a new message that is passed to the payment channel-specific interface 406.

In some embodiments, payment channel-specific interface 406 can analyze the fields of the new message and pass the new message to an entry point module of the merchant processor computer 130. In some embodiments, the payment channel-specific interface may add additional data to the new message based on the analysis. For example, if the payment channel-specific interface 406 determines that the content of the new message is encrypted, it may add an encryption flag that prompts merchant processor 130 to decrypt the contents of the new message before attempting other processing. In some embodiments, payment channel-specific interface 406 may add additional information, such as originating merchant, time/date stamp information, and other information that may be used by merchant processor computer 130 to determine how to process the message.

Response messages may be processed similarly from merchant processor computer 130 through the payment channel-specific interface. The response message can be transformed by the bridge 404 from the merchant processor computer format to a format compatible with the corresponding payment channel and returned to the requesting switch through channel endpoint 402. In some embodiments, different channel interfaces may include bridges that implement different transformations, depending on the format of messages that are sent over the corresponding payment channel.

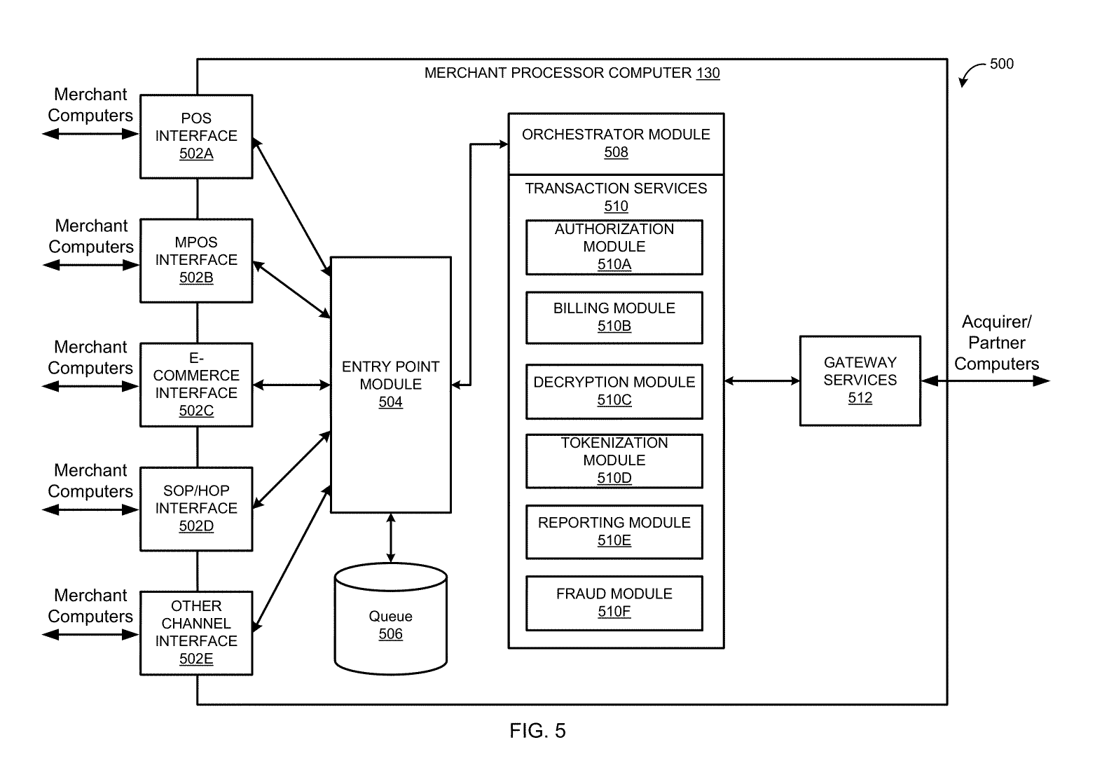

FIG. 5 illustrates an example merchant processor computer according to embodiments of the invention. As shown in FIG. 5, merchant processor computer 130 can include a plurality of channel interfaces 502. Each channel interface 502 may be configured to receive messages that originate over a different payment channel, as described above with respect to FIG. 4. For example, POS interface 502A may be configured to receive messages that originate from a retail POS access device, mPOS interface 502B may be configured to receive messages that originate from a mobile POS access device, e-commerce interface 502C may be configured to receive messages that originate from a merchant e-commerce computer, and SOP/HOP interface 502D may be configured to receive messages that are received via a silent order post of hosted order page. Although particular channel interfaces are described herein, merchant processor computer 130 can be configured to include other channel interfaces 502E as needed.

When messages are received at each channel interface 502, the messages can be transformed and analyzed as described above with respect to FIG. 4. The transformed messages can then be sent to entry point module 504. As transformed messages are received by entry point module 504, the transformed messages can be added to queue 506. In some embodiments, message transformation can be performed by entry point module 504, prior to enqueuing the messages. Entry point module 504 is also in communication with orchestrator module 508. As messages are processed, entry point module 504 can dequeue the next message from queue 506 and send the message to orchestrator module 508.

Orchestration module 508 can automatically identify, coordinate, and execute transaction services 510 for each message received by merchant processor 130. This may include message routing from service to service and ensuring quality of service requirements such as workload management, volume throughput, and average response times. In some embodiments orchestration module 508 can determine which transaction services 510 are to be performed on a given message and a sequence in which those transaction services are to be performed. The orchestration module 508 can determine an orchestration workflow to perform on a given message based on the contents of the message, such as which fields of the message include data and/or the data types included in the message. For example, for messages that include encrypted data, orchestration module 508 may select an orchestration workflow that includes a decryption service. Orchestration workflows may also be defined by the acquirer bank, issuer bank, and/or merchant associated with a transaction. Different orchestration workflows may also be defined based on country of origin, card account type, and currency. For example, for foreign currency transactions orchestration module 508 may automatically select an orchestration workflow that includes a currency conversion service. Similarly, different merchants may request different reporting services, or they may request that risk assessment services be executed before the authorization service is executed.

In some embodiments, merchants may define different orchestration workflows for their transactions that are made over different payment channels. For example, an orchestration workflow for in-store pickup e-commerce transactions may include fraud and risk management services prior to authorization, because there may be limited time between when the order is placed and when the consumer arrives to pick up the order. However, an orchestration workflow for an e-commerce transaction that will be fulfilled by mail may include fraud and risk management services after authorization, but before shipping. This allows these merchants to approve these transactions more quickly, improving the consumer experience, and use the time required to prepare the order for shipment to identifying potentially fraudulent transactions before the order has been fulfilled. Similarly, retail transactions performed in a checkout line may be associated with different orchestration workflows than retail transactions performed at a self-service kiosk.

In some embodiments, merchant, acquirer, and/or issuer orchestration preferences may be maintained by merchant processor computer 130. The preferred orchestration workflow may then be selected by default by orchestration module 508. However, merchants may request alternative orchestration workflows by including the request in the transaction data. For example, a merchant may define several alternative orchestration workflows, each associated with a different identifier. The merchant may then include the identifier corresponding to the desired orchestration workflow with each transaction. If the transaction includes no orchestration workflow identifier, then a default orchestration workflow may be executed.

Each of the transaction services 510 can be payment channel agnostic. That is, each transaction service may be configured to process any transaction data it receives, regardless of which payment channel was used to communicate that transaction data. Thus, transaction services do not have to be developed for each payment channel, which would result in costly and duplicative work. However, because transactions originating over different payment channels may be associated with different transaction data, the result of a given transaction service may vary. For example, tokenization module 510D may use any available transaction data to build a token profile. So e-commerce transactions, which typically include detailed transaction data, such as billing address, ZIP code, and e-mail, may generate more sophisticated token profiles than retail transactions which may only include data from the consumer's payment device.

In some embodiments, transaction services 510 may include both synchronous and asynchronous services. For example, authorization service 510A may operate synchronously, opening a connection to an acquirer computer, requesting an authorization from the acquirer computer, and holding the connection open until a response is received from the acquirer computer. Once the response is received, the synchronous event is completed and the orchestration module 508 may invoke the next transaction service in the orchestration workflow. Other transaction services, such as settlement services may be executed asynchronously. For example, settlement messages may be sent for each transaction authorized and aggregated into a batch that is sent on a periodic basis. When a settlement response is received, at a later time, the orchestration module can then invoke the next transaction service in the orchestration workflow.

In one example of a simple orchestration workflow, a zero dollar authorization request may be received from a merchant, e.g. to verify a consumer's identity, generate a token for the consumer, and/or verify that a payment card account is valid. When the transaction data is received by the orchestration module, the orchestration module may identify that it is a zero dollar transaction and select a zero dollar transaction orchestration workflow associated with that merchant. The orchestration module can send the transaction data to authorization module 510A, which may then send a request to gateway services 512 to send an authorization request to an acquirer computer. The authorization request is a synchronous service, so processing waits for a response. If the response authorizes the transaction, then the orchestration module can be notified that the authorization module has completed successfully, and the orchestration module may then invoke a fraud check module 510F. If the transaction passes the fraud check, then the orchestration module may invoke tokenization module 510D to generate a token for the payment card account. Once the token has been generated, the orchestration module may then generate a response message that include the transaction authorization from authorization module 510A and the token generated by tokenization module 510D. The response message may then be returned to the merchant through the entry point module 504 and the channel interface over which the request was received.

Gateway services 512 can include components for routing requests from transaction services 510 to external entities, such as acquirer computers, issuer computers, payment processing network computers, and/or other third party service providers such as value added service providers. Gateway services 512 may maintain a directory of IP addresses associated with the various external entities and any protocol or other communication requirements for the external entities. When a request is received from a transaction service, the gateway services can look up the address associated with the recipient, transform the request, if needed, and send the request to the recipient.

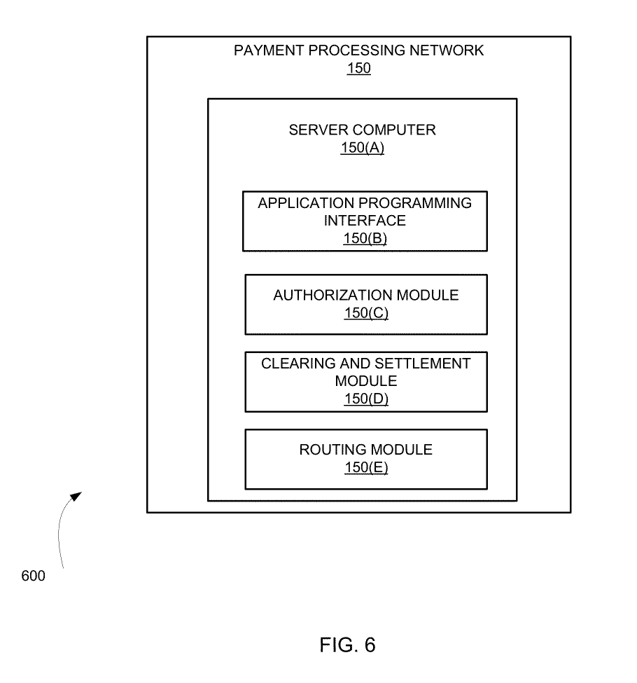

FIG. 6 illustrates an example payment processing network according to embodiments of the invention. As shown in FIG. 6, payment processing network 150 may comprise a server computer 150(A) comprising an application programming interface 150(B), an authorization module 150(C), a clearing and settlement module 124(D), and a routing module 150(E). Payment processing network 150 may include data processing subsystems, networks, and operations used to support and deliver authorization services, exception file services, and clearing and settlement services. An example payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system which performs clearing and settlement services. Payment processing network 150 may use any suitable wired or wireless network, including the Internet.

Authorization module 150(C) processes authorization request messages and determines the appropriate destination for the authorization request messages. Clearing and settlement module 150(D) handles the clearing and settlement of transactions. These modules authenticate user information and organize the settlement process of user accounts between acquirer computer 150 and issuer computer 160. An example of the clearing and settlement module is Base II, which provides clearing, settlement, and other interchange-related services to VISA members.

Routing module 150(E) handles the routing of authorization request messages from acquirer computer 140 to issuer computer 160, and the routing the authorization response messages back from issuer computer 160 to acquirer computer 140.

### II. EXAMPLE METHODS

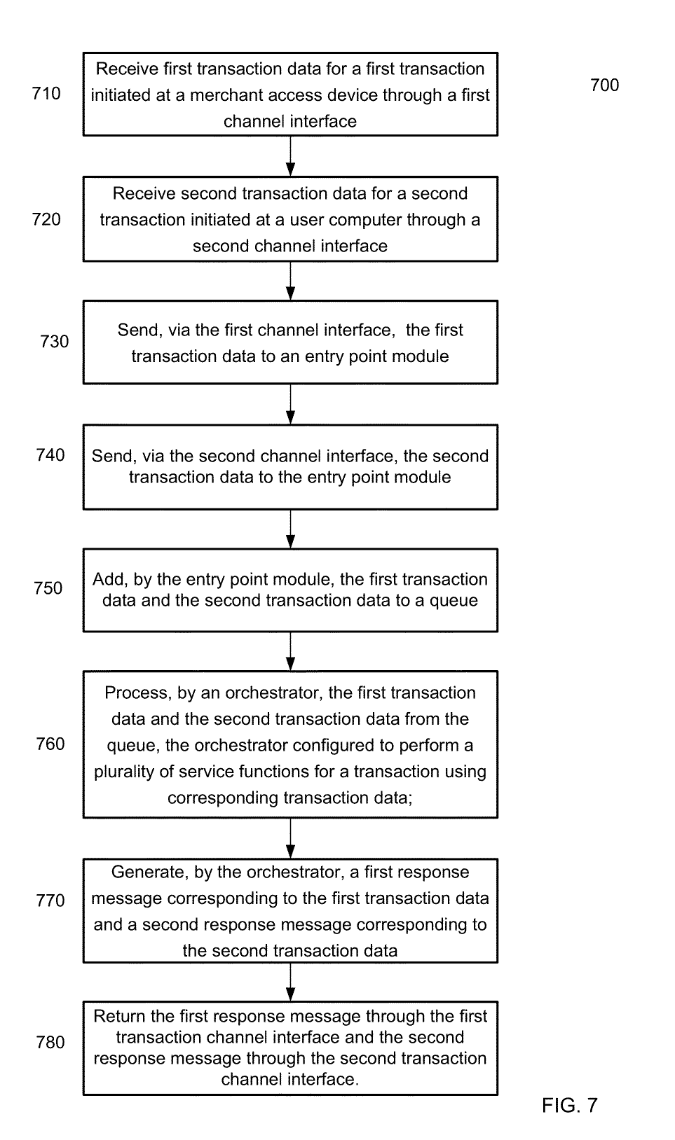

FIG. 7. is a flowchart of a method 700 for processing payment transactions originating over a plurality of different channels according to embodiments of the present invention.

At block 710, first transaction data for a first transaction initiated at a merchant access device can be received through a first channel interface. For example, this may include receiving a transaction data in an ISO 8583 message from a retail POS. In some embodiments, the transaction data may be received from a POS terminal via a retail switch that manages transactions originating from a merchant's retail enterprise.

At block 720, second transaction data for a second transaction initiated at a user computer can be received through a second channel interface. This may include receiving transaction data for an e-commerce transaction from a merchant's e-commerce server. In some embodiments, the transaction data may be received from the merchant's e-commerce server via an e-commerce gateway that manages transactions originating from a merchant's e-commerce system.

At block 730, the first transaction data can be sent, via the first channel interface, to an entry point module. As described above, the entry point module can serve as a central point to manage all incoming and outgoing messages regardless of the payment channel associated with those messages.

At block 740, the second transaction data can be sent, via the second channel interface, to the entry point module. As described above, in some embodiments, when transaction data is received by a channel interface it can be transformed into a common, merchant processor compatible format. As such, when transaction data is received by the entry point module, transaction services can be performed on the transaction data regardless of the payment channel from which it originated.

At block 750, the entry point module can add the first transaction data and the second transaction data to a queue. As described above, in some embodiments, the entry point module may be in communication with a plurality of queues and may load balance messages between multiple queues based on the order in which the messages are received and/or based on the contents of each message.

At block 760, an orchestrator can process the first transaction data and the second transaction data from the queue. The orchestrator can be configured to perform a plurality of service functions for a transaction using corresponding transaction data. In some embodiments, the orchestrator can process multiple messages in parallel. In some embodiments, a given message can be processed by multiple transaction service functions in parallel at the same time.

At block 770, the orchestrator can generate a first response message corresponding to the first transaction data and a second response message corresponding to the second transaction data. Each response message can be generated based on the results of each service function performed on the transaction data.

At block 780, the orchestrator can then return the first response message through the first channel interface to the merchant access device and the second response message through the second channel interface to the user computer. In some embodiments, each response message can be passed from the orchestrator module to the entry point module. The entry point module can then send the response message back to the requesting computer through the appropriate channel interface.

### III. SWITCH CONFIGURATION

As described above, systems disclosed herein operate in part by reconfiguring retail switches to direct outbound messages to a merchant processor computer rather than an acquirer computer. This makes the various transaction services offered by the merchant processor available to a merchant's transactions, regardless of the payment channel used to make the transaction. This reconfiguration can involve, at least, both communication management changes and encryption management changes (e.g., the switch needs to be reconfigured to direct messages to a new recipient, and the switch needs to be reconfigured to send messages that the new recipient is able to process).

### A. Communication and Encryption Management

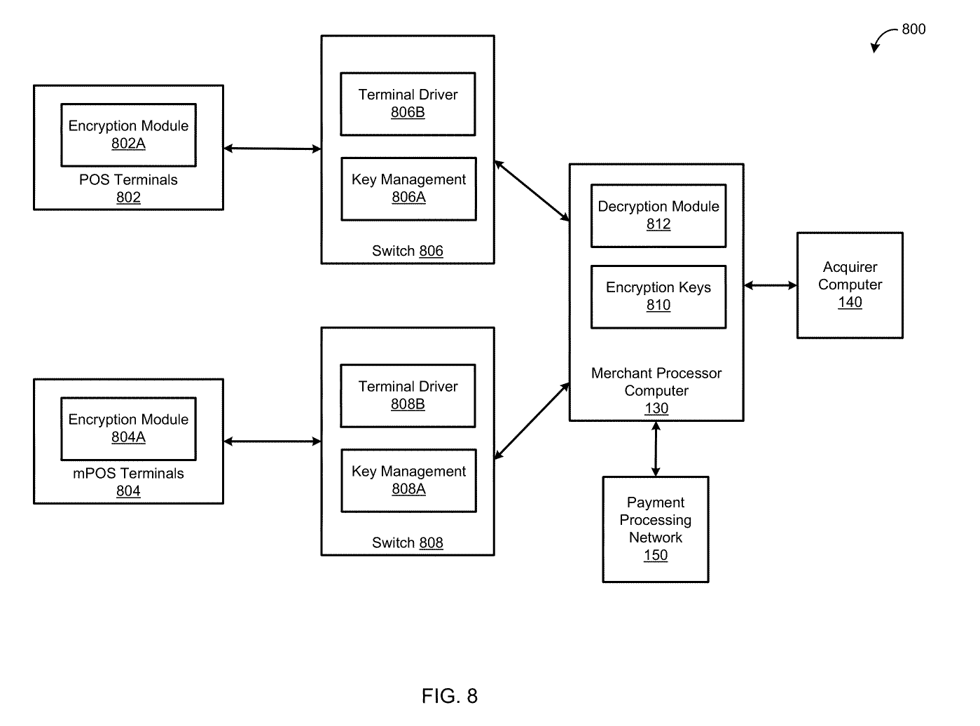

FIG. 8 illustrates an example block diagram of an encryption management system of a payment transaction system with separate payment channels, according to embodiments of the present invention. As shown in FIG. 8, in embodiments of the present invention a merchant processor computer 130 can receive and process transaction requests from a plurality of retail payment channels that would otherwise bypass the merchant processor computer 130 and be sent directly to acquirer computer 140.

To protect customer information, payment details received by a merchant's POS terminals, including retail POS terminals 802 and mPOS terminals 804, can be encrypted. An encryption module at each terminal, such as encryption module 802A and 804A, can use one or more encryption keys to encrypt the consumer's data before it leaves the terminal. As described above, a merchant's POS terminals may send messages to and be managed by one or more switches. Each switch can route messages to and from its connected terminals and provide transaction workflow management and encryption management for the connected terminals. For example, as shown in FIG. 8, the merchant may choose to implement one switch 806 that manages all of its retail POS terminals 802 and another switch 808 that manages all of its mPOS terminals 804. In other embodiments, the same switch may be configured to manage all terminals in a given merchant location.

In some embodiments, each mPOS terminal 804 is a mobile device, such as a tablet computer, smartphone, or other device, maintained by the merchant, that has been configured to serve as a point of sale terminal. In some embodiments, part of this configuration can include coupling a hardware payment device reader to the mobile device, such as a magnetic card reader, RFID reader, NFC reader, etc. When mPOS 804 receives the encryption key(s) from switch 808, it can inject the encryption key(s) into firmware associated with the reader device. Subsequently, when the reader device captures data from a consumer's payment device, the reader device can automatically encrypt the data using the encryption key(s).

Each switch may include a key management module 806A and 808A that implements one or more key management systems across the switch's connected terminals. An encryption key management system, such as Derived Unique Key Per Transaction (DUKPT), can be used in which each terminal performs encryption using a derived key which is derived from a base key maintained by the intended recipient (e.g., the merchant processor computer, payment processing network computer, or an acquirer computer). When an encrypted message is received by the merchant processor computer, it can use its base key to decrypt the message.

In some embodiments, each key management module 806A and 808A can receive one or more sets of encryption keys 810 from merchant processor computer 130. The encryption keys 810 maintained by the merchant processor computer 130 may be derived from one or more encryption keys maintained by payment processing network 150, acquirer 140, or a third party security provider (not shown). The use of derived keys as each component of the system can limit the security risk posed by any one key being compromised leading to a systemic security breach. When merchant processor computer 130 receives encrypted data from POS terminals 802 and mPOS terminals 804, decryption module 812 can use the encryption keys 810 to decrypt the data and then send the decrypted data to the next transaction service function according to instructions from orchestrator module 508, as described above.

Each switch may additionally include a terminal driver 806B and 808B that implements predefined transaction workflows at each connected terminal. A transaction workflow may include a series of steps executed by a terminal that prompts the user to provide information and then processes that information. Each terminal may offer different functionality and therefore may support different transaction workflows. The terminal driver 806B and 808B can manage a plurality of terminals. Transaction workflows may be defined by the merchant, by the terminal manufacturer, by the payment processor, or by a combination of parties to ensure that the correct data is received from the consumer and processed securely. For example, a kiosk POS terminal may prompt a user to select a payment method. Based on the selected payment methods, the user may then be prompted to provide payment details (such as by swiping a payment card at an attached card reader). The terminal may collect the data and encrypt the data. The user may then be prompted to provide additional data, such as a signature or PIN. Such user prompts and data processing may continue until the transaction is complete.

### B. Method of Switch Configuration

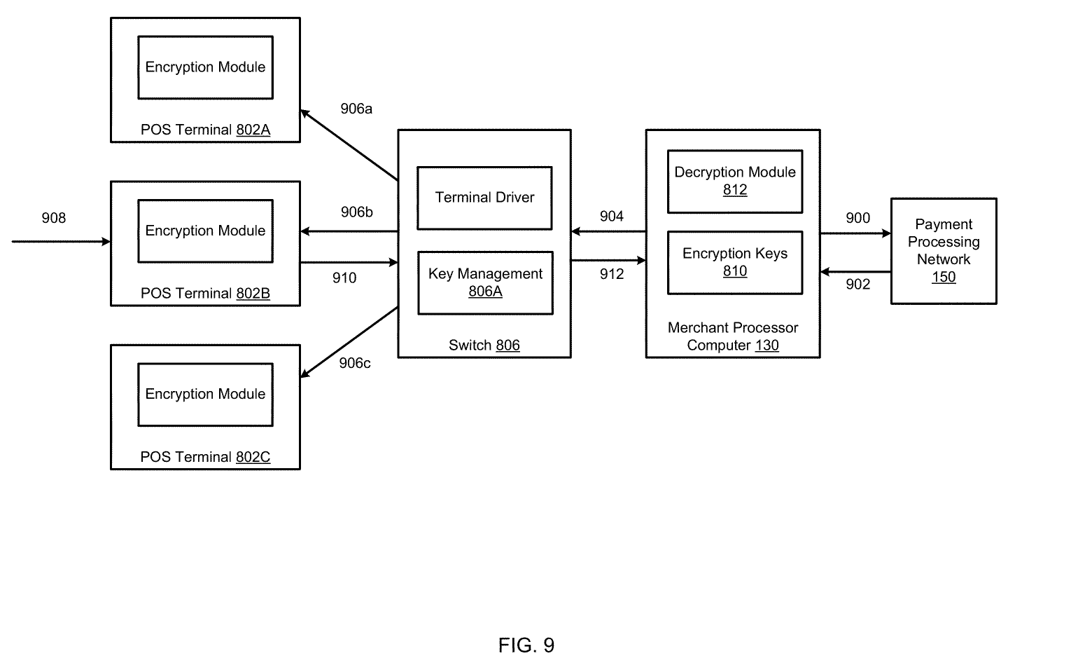

FIG. 9 shows a system and a corresponding workflow for configuring switches in multiple payment channels according to embodiments of the present invention. As shown in FIG. 9, a merchant processor computer 130 can request 900 one or more encryption keys from a payment processing network computer 150. The payment processing network computer may generate encryption keys and send 902 the one or more encryption keys to the merchant processor computer 130. The merchant processor computer 130 can then send a request 904 to a switch 806 to configure each POS terminal 802 connected to the switch. The request may include at least one of the one or more encryption keys received from the payment processing network computer. In some embodiments, merchant processor computer may generate one or more derived keys based on the at least one encryption key received from the payment processing network computer, and send the derived key in the request at 904. Switch 806 can update its key management module with the encryption key(s) received from merchant processor computer 130.

Switch 806 can configure each connected terminal 802 using the encryption key(s) received from the merchant processor computer to enable each terminal to securely receive and encrypt payment data received from a consumer, and to ensure that recipients of that data (such as the merchant processor computer) are able to decrypt and process that data. Key management module 806A can send requests 906a, 906b, and 906c, including one or more encryption keys, to each connected terminal to inject the one or more encryption keys to each terminals encryption module. In some embodiments, each encryption module can be a hardware encryption module that uses an encryption key stored in firmware of a card reader that is coupled to the terminal to securely encrypt payment data received at the terminal from a consumer. Each terminal may be associated with a different key update procedure and/or request format. The switch 806 can identify the update procedure and request format associated with each connected terminal 802 and format each request 906a, 906b, 906c accordingly.

Subsequently, when a transaction is performed using one of the POS terminals, the POS terminal can prompt the consumer to provide payment data, such as by swiping a payment card. At 908, the consumer provides the requested payment data and the data is encrypted using the merchant processor computer's encryption key(s) An authorization request message is generated by the POS terminal using the encrypted data and sent 910 to the switch 806. The switch 806 receives the authorization request message which includes an encrypted payload and may include one or more plain text fields. The switch 806 can route 912 the authorization request message to merchant processor computer 130 where it is received by a channel interface corresponding to the switch, as described above. The message may then be processed by a decryption module 812 using the one or more encryption keys 810 maintained by merchant processor computer 130, before being further processed, as described above. In some embodiments, encryption keys may be maintained by the payment processing network 150, and the merchant processor computer 130 may send requests to a payment processing network security module (not shown) to provide keys and/or decryption services on a per transaction basis optional post.

As described above, embodiments of the present invention may provide end to end encryption services to a plurality of different payment channels representing different hardware devices and communication architectures. This unified encryption mechanism provides a simplified, cheaper encryption solution that requires merchants to manage fewer encryption methods for fewer recipient parties. Encryption management can be offloaded from merchants and centrally managed by a merchant service provider along with the various other services, such as tokenization, risk assessment, authorization, and other services that are already provided. Thus, if security standards or encryption mechanisms change, the merchant service provider can transparently upgrade the encryption services without imposing management or upgrade responsibilities on individual merchants. This may generally increase the rate at which security improvements are adopted, improving the experience for customers and merchants.

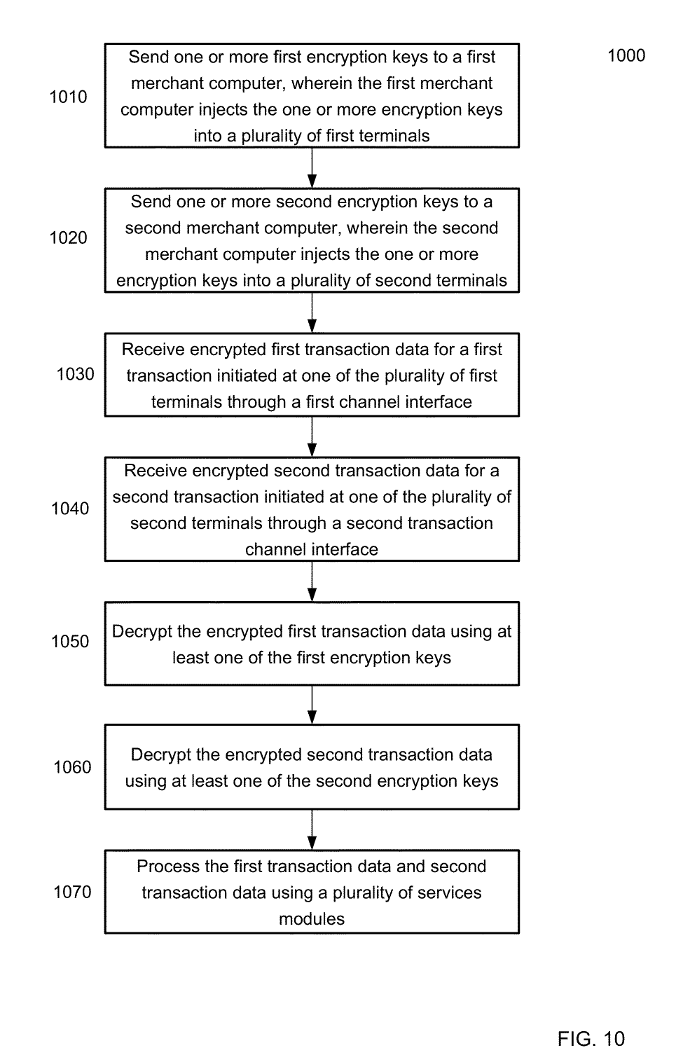

FIG. 10 is a flowchart of a method 1000 for managing encryption in a payment processing system according to embodiments of the present invention.

At block 1010, one or more first encryption keys may be sent to a first merchant computer. The first merchant computer can injects the one or more encryption keys into a plurality of first terminals. As described above, the first merchant computer may be a switch in communication with a plurality of POS terminals at a merchant location. The switch may be configured to send the one or more encryption keys to the POS terminals where they can be stored in firmware and used to perform hardware encryption.

At block 1020, one or more second encryption keys can be sent to a second merchant computer. The second merchant computer injects the one or more encryption keys into a plurality of second terminals. The second merchant computer may be a switch managing POS terminals for a different payment channel (such as an mPOS switch) or may be a switch managing POS terminals on the same payment channel but at a different merchant location.

After the encryption keys have been injected to the merchant's terminals, transaction data can be encrypted using the encryption keys.

At block 1030, encrypted first transaction data for a first transaction initiated at one of the plurality of first terminals can be received through a first channel interface. For example, a consumer may swipe their payment card at a retail POS terminal. The card reader may automatically encrypt the data captured from the payment card using the one or more first encryption keys. The retail POS terminal can then generate and send an authorization request using the encrypted payment card data to the merchant processor computer.

At block 1040, encrypted second transaction data for a second transaction initiated at one of the plurality of second terminals can be received through a second channel interface. For example, a consumer may swipe their payment card at a card reader coupled to an mPOS terminal. The card reader may automatically encrypt the data captured from the payment card using the one or more second encryption keys and send the encrypted data to the mPOS terminal. The mPOS terminal can then generate and send an authorization request using the encrypted payment card data to the merchant processor computer.

Using the new keys, at block 1050, a decryption module can decrypt the encrypted first transaction data using at least one of the first encryption keys. In some embodiments, the transaction data may be sent to an entry point module from the channel interface. An orchestration module may retrieve the transaction data from the entry point module, identify that the transaction data is encrypted and invoke the decryption module to decrypt the transaction data before performing other service functions. In other embodiments, the decryption module may be automatically invoked by the channel interface. In some embodiments, the decryption module may request the keys from a payment processing network computer to decrypt transactions.

Similarly, at block 1060, the decryption module can decrypt the encrypted second transaction data using at least one of the second encryption keys. In some embodiments, the first and second encryption keys may be the same encryption keys. In some embodiments, the first and second encryption keys may be derived from the same base encryption key received from a payment processing network computer.

At block 1070, the first transaction data and second transaction data can be processed using a plurality of services modules. For example, as described above, an orchestration module may identify an orchestration workflow for each of the first transaction data and second transaction data and then execute a series of service functions according to each orchestration workflow.

### IV. COMPUTER SYSTEM

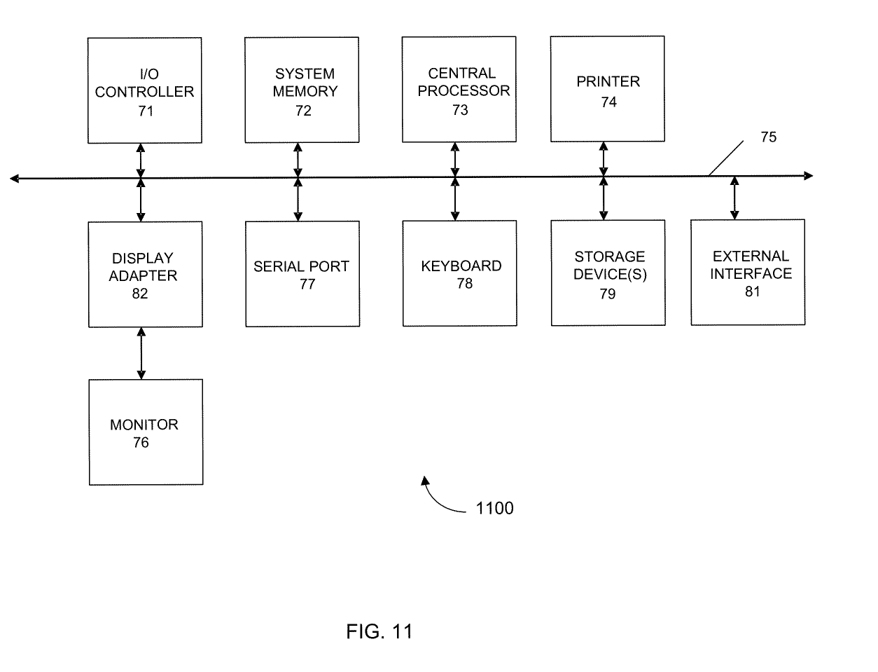

FIG. 11 is a high level block diagram of a computer system that may be used to implement any of the entities or components described above.

The subsystems shown in FIG. 11 are interconnected via a system bus 75. Additional subsystems such as a printer 74, keyboard 78, storage device(s) 79, monitor 76, which is coupled to display adapter 82, and others are shown. Peripherals and input/output (I/O) devices, which couple to I/O controller 71, can be connected to the computer system by any number of means known in the art, such as serial port 77. For example, serial port 77 or external interface 81 (e.g. Ethernet, Wi-Fi, etc.) can be used to connect computer system 1100 to a wide area network such as the Internet, a mouse input device, or a scanner. The interconnection via system bus 75 allows the central processor 73 to communicate with each subsystem and to control the execution of instructions from system memory 72 or the storage device(s) 79 (e.g., a fixed disk, such as a hard drive or optical disk), as well as the exchange of information between subsystems. The system memory 72 and/or the storage device(s) 79 may embody a computer readable medium. Any of the data mentioned herein can be output from one component to another component and can be output to the user.

It should be understood that any of the embodiments of the present invention can be implemented in the form of control logic using hardware (e.g. an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C# or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for comprising:
receiving, at a server computer, first transaction data for a first transaction initiated at a merchant access device through a first channel interface of the server computer;
receiving, at the server computer, second transaction data for a second transaction initiated at a user computer through a second channel interface of the server computer;
sending, via the first channel interface, the first transaction data to an entry point module of the server computer;
sending, via the second channel interface, the second transaction data to the entry point module of the server computer;
adding, by the entry point module, the first transaction data and the second transaction data to a queue;
processing, by an orchestrator of the server computer, the first transaction data and the second transaction data from the queue, the orchestrator configured to perform a plurality of service functions for a transaction using corresponding transaction data;
generating, by the orchestrator, a first response message corresponding to the first transaction data and a second response message corresponding to the second transaction data;
returning the first response message through the first channel interface to the merchant access device and the second response message through the second channel interface to the user computer.

2. The method of claim 1, wherein the first channel interface includes a first bridge module, wherein the first bridge module is configured to transform the first transaction data from a first format to a merchant processor format.

3. The method of claim 1, wherein the first transaction data is received at the first channel interface from a switch that is configured to receive transaction data from a plurality of merchant access devices, and wherein the second transaction data is received at the second channel interface from a gateway that is configured to receive transaction data from a plurality of user computers.

4. The method of claim 1, further comprising:
identifying, by the orchestrator, a first orchestration workflow to process the first transaction data and a second orchestration workflow to process the second transaction data, wherein each orchestration workflow includes at least one of the plurality of service functions; and
executing, by the orchestrator, the first orchestration workflow and the second orchestration workflow.

5. The method of claim 4, wherein the first orchestration workflow is defined by a merchant and associated with the first channel interface, and the second orchestration workflow is defined by the merchant and associated with the second channel interface.

6. The method of claim 4, wherein the first orchestration workflow is identified based on the first transaction data and the second orchestration workflow is identified based on the second transaction data.

7. The method of claim 4, wherein the first orchestration workflow and the second orchestration workflow both include a same service function.

8. A system comprising one or more processors configured to:
receive first transaction data for a first transaction initiated at a merchant access device through a first channel interface of the server computer;
receive second transaction data for a second transaction initiated at a user computer through a second channel interface of the server computer;
send, via the first channel interface, the first transaction data to an entry point module of the server computer;
send, via the second channel interface, the second transaction data to the entry point module of the server computer;
add, by the entry point module, the first transaction data and the second transaction data to a queue;
process, by an orchestrator, the first transaction data and the second transaction data from the queue, the orchestrator configured to perform a plurality of service functions for a transaction using corresponding transaction data;
generate, by the orchestrator, a first response message corresponding to the first transaction data and a second response message corresponding to the second transaction data;
return the first response message through the first channel interface to the merchant access device and the second response message through the second channel interface to the user computer.

9. The system of claim 8, wherein the first channel interface includes a first bridge module, wherein the first bridge module is configured to transform the first transaction data from a first format to a merchant processor format.

10. The system of claim 8, wherein the first transaction data is received at the first channel interface from a switch that is configured to receive transaction data from a plurality of merchant access devices, and wherein the second transaction data is received at the second channel interface from a gateway that is configured to receive transaction data from a plurality of user computers.

11. The system of claim 8, wherein the orchestrator is further configured to:
identify a first orchestration workflow to process the first transaction data and a second orchestration workflow to process the second transaction data, wherein each orchestration workflow includes at least one of the plurality of service functions; and
execute the first orchestration workflow and the second orchestration workflow.

12. The system of claim 11, wherein the first orchestration workflow is defined by a merchant and associated with the first channel interface, and the second orchestration workflow is defined by the merchant and associated with the second channel interface.

13. The system of claim 11, wherein the first orchestration workflow is identified based on the first transaction data and the second orchestration workflow is identified based on the second transaction data.

14. The system of claim 11, wherein the first orchestration workflow and the second orchestration workflow both include a same service function.

15. A method for managing encryption of transactions, the method comprising:
sending, by a server computer, one or more first encryption keys to a first merchant computer, wherein the first merchant computer injects the one or more encryption keys into a plurality of first terminals;
sending, by the server computer, one or more second encryption keys to a second merchant computer, wherein the second merchant computer injects the one or more encryption keys into a plurality of second terminals;
receiving, at the server computer, encrypted first transaction data for a first transaction initiated at one of the plurality of first terminals through a first channel interface of the server computer;
receiving, at the server computer, encrypted second transaction data for a second transaction initiated at one of the plurality of second terminals through a second channel interface of the server computer;
decrypting, by a decryption module at the server computer, the encrypted first transaction data using at least one of the first encryption keys;
decrypting, by the decryption module at the server computer, the encrypted second transaction data using at least one of the second encryption keys; and
processing, by the server computer, the first transaction data and second transaction data using a plurality of service modules.

16. The method of claim 15, wherein the one or more first encryption keys and the one or more second encryption keys are derived from at least one encryption key received from a payment processing network computer.

17. The method of claim 15, wherein the plurality of first terminals are retail point of sale terminals.

18. The method of claim 17, wherein the plurality of second terminals are mobile point of sale terminals.

19. The method of claim 15, wherein each of the plurality of second terminals is communicatively coupled to a card reader, and wherein the one or more encryption keys are injected by each of the plurality of second terminals into its corresponding card reader.

20. The method of claim 15, wherein the decryption module at the server computer requests an encryption key from a payment processing network computer to decrypt each transaction.
